(19) United States
(12) Patent Application Publication
(10) Pub. No.: US 2011/0189554 A1
(43) Pub. Date: Aug. 4, 2011

(54) HUMIDIFICATION UNIT AND FUEL CARTRIDGE

(75) Inventors: Po-Kuei Chou, Hsinchu County (TW); Cheng Wang, Hsinchu County (TW); Yueh-Chang Wu, Hsinchu County (TW)

(73) Assignee: YOUNG GREEN ENERGY CO., HSINCHU COUNTY (TW)

(21) Appl. No.: 13/004,033

(22) Filed: Jan. 11, 2011

(30) Foreign Application Priority Data
Jan. 29, 2010 (CN) 201010106792.2

(51) Int. Cl. H01M 8/06

(52) U.S. Cl. 429/413

(57) ABSTRACT

A humidification unit and a fuel cartridge are provided, wherein the fuel cartridge is capable of supplying hydrogen gas to a fuel cell (FC) stack. The fuel cartridge includes a hydrogen supply unit and a humidification unit. The hydrogen supply unit is capable of generating the hydrogen gas. The humidification unit is connected with the hydrogen supply unit. The humidification unit includes a first chamber, a second chamber, a membrane, and at least one membrane destructor. The first chamber contains water, and the second chamber contains a water absorbing material. The membrane is disposed between the first chamber and the second chamber. The membrane destructor is connected to the membrane. The water in the first chamber flows into the second chamber and is absorbed by the water absorbing material when a hole is formed on the membrane by the membrane destructor.

### CROSS-REFERENCE TO RELATED APPLICATION

This application claims the priority benefit of China application serial no. 201010106792.2, filed on Jan. 29, 2010. The entirety of the above-mentioned patent application is hereby incorporated by reference herein and made a part of this specification.

### BACKGROUND OF THE INVENTION

1. Field of the Invention

The invention generally relates to a fuel cell (FC) system, and more particularly, to a fuel cartridge with a humidification unit.

2. Description of Related Art

The exploitation and application of energy sources have always been a critical part of human life. However, the conventional techniques for exploiting and applying energy sources have caused vast environmental damage. The fuel cell (FC) technique is a highly efficient, low-noise, and non-polluting energy generation technique therefore is very promising in the industry.

In short, a FC is a device that converts chemical energy into electrical energy through reverse water electrolysis reaction. There are many different types of FCs, wherein a proton exchange membrane fuel cell (PEMFC) and a direct methanol fuel cell (DMFC) are two commonly-used FCs. Taking a PEMFC as an example, a FC stack module in the PEMFC is composed of a membrane electrode assembly (MEA) and a cathode and an anode respectively disposed at sides of the MEA. The MEA is composed of a proton exchange membrane, an anode catalyst layer, a cathode catalyst layer, an anode gas diffusion layer (GDL), and a cathode GDL. The anode catalyst layer and the cathode catalyst layer are respectively disposed at sides of the proton exchange membrane, and the anode GDL and the cathode GDL are respectively disposed on the anode catalyst layer and the cathode catalyst layer.

At the anode of a PEMFC, hydrogen molecules react with the anode catalysts to generate hydrogen ions H⁺ and electrons e⁻. The chemical formula of this reaction is 2H₂→4H⁺+4e⁻. The electrons e⁻ generated in the anode reaction move towards the cathode through an external circuit so as to be used by a load. The hydrogen ions H⁺ generated in the anode reaction move to the cathode through the proton exchange membrane and react with oxygen molecules and the electrons from the external circuit at the cathode side to generate water. The chemical formula of this reaction is 4H⁺+4e⁻+O₂→2H₂O. Thereby, the general chemical reaction equation of PEMFC is 2H₂+O₂→2H₂O.

Generally speaking, protons move freely when the proton exchange membrane is moisturized. Thus, a humidifier is usually disposed in the PEMFC for humidifying the proton exchange membrane. However, humidifier is not suitable for portable FC due to its bulky size and costly price. The performance of the FC stack module in a FC will be affected if the proton exchange membrane is not moisturized enough. Thereby, how to make a proton exchange membrane to retain its humidity and smoothly conduct protons is still one of the major subjects.

### SUMMARY OF THE INVENTION

Accordingly, the invention is directed to a fuel cartridge with a humidification unit, wherein hydrogen gas generated by the fuel cartridge is adequately humidified, and therefore may be directly conducted into a fuel cell (FC) stack.

Additional aspects and advantages of the invention will be set forth in part in following description.

According to an embodiment of the invention, a fuel cartridge capable of supplying hydrogen gas to a FC stack is provided. The fuel cartridge includes a hydrogen supply unit and a humidification unit. The hydrogen supply unit is capable of generating the hydrogen gas. The humidification unit is connected with the hydrogen supply unit. The humidification unit includes a first chamber, a second chamber, a membrane, and at least one membrane destructor. The first chamber contains water, and the second chamber contains a water absorbing material. The membrane is disposed between the first chamber and the second chamber. The membrane destructor is connected to the membrane. The water in the first chamber flows into the second chamber and is absorbed by the water absorbing material when a hole is formed on the membrane by the membrane destructor.

According to another embodiment of the invention, a humidification unit adapted to a fuel cartridge is provided. The humidification unit includes a first chamber, a second chamber, a membrane, and at least one membrane destructor. The first chamber contains water, and the second chamber contains a water absorbing material. The membrane is disposed between the first chamber and the second chamber. The membrane destructor is connected to the membrane. The water in the first chamber flows into the second chamber and is absorbed by the water absorbing material when a hole is formed on the membrane by the membrane destructor.

Based on the above, in an embodiment of the invention, when hydrogen gas generated by a fuel supply unit passes through the humidification unit connected with the fuel supply unit, the humidification unit humidifies the hydrogen gas. The hydrogen gas properly humidified by the humidification unit is conducted into a FC stack and humidifies the proton exchange membrane. Thus, no complicated humidifier is to be disposed in the FC system, and accordingly the performance of the system may be maintained or even improved. Otherwise, the humidification unit disposed in the fuel cartridge has two chambers separated by a membrane, one chamber contains water, and the other chamber contains a water absorbing material, such that when a hole is formed on the membrane by the membrane destructor, the water in the first chamber flows into the second chamber and is absorbed by the water absorbing material.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are respectively a cross-sectional diagram of a fuel cartridge before and after its operation according to an embodiment of the invention.

FIG. 2A and FIG. 2B are respectively a cross-sectional diagram of a fuel cartridge before and after its operation according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

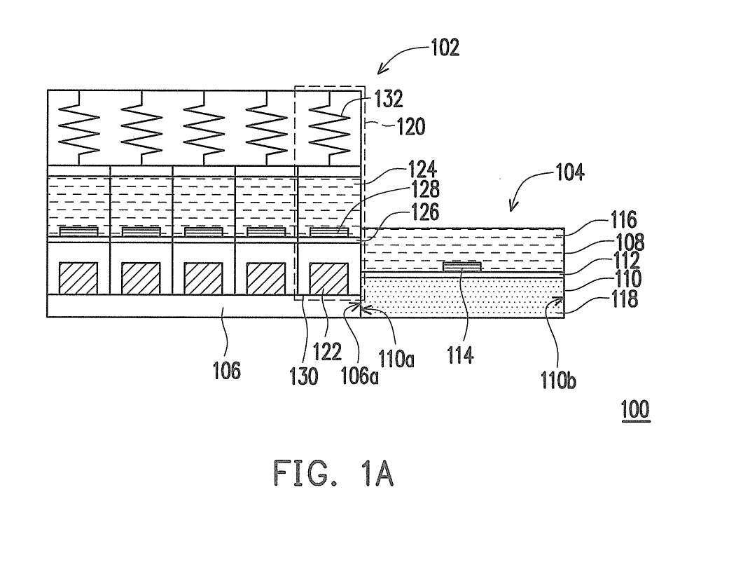

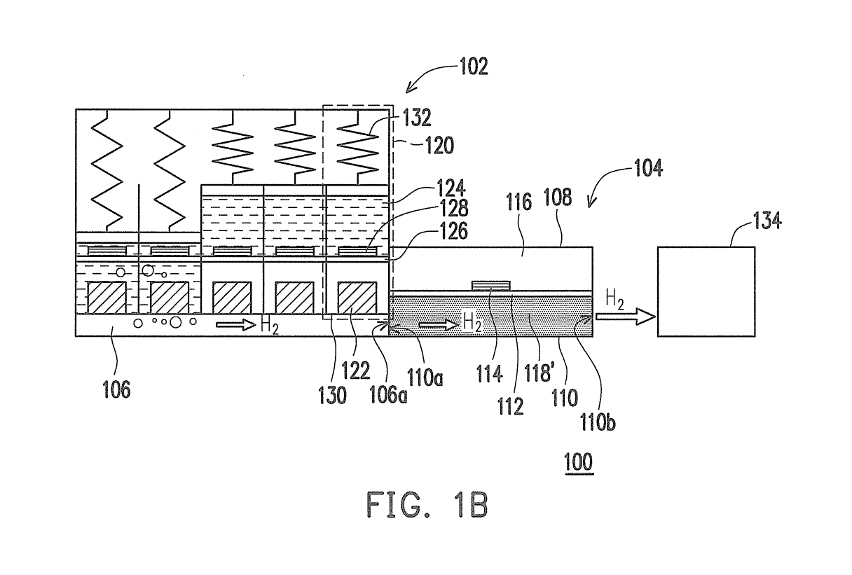

FIG. 1A and FIG. 1B are respectively a cross-sectional diagram of a fuel cartridge before and after its operation according to an embodiment of the invention. Referring to FIG. 1A, the fuel cartridge 100 includes a hydrogen supply unit 102, a humidification unit 104, and a hydrogen flow channel 106, wherein the hydrogen supply unit 102 and the humidification unit 104 are connected with the hydrogen flow channel 106.

The hydrogen supply unit 102 generates hydrogen gas, and the hydrogen flow channel 106 is served as a passage for the hydrogen gas to enter the humidification unit 104.

The humidification unit 104 includes a first chamber 108, a second chamber 110, a membrane 112, and a membrane destructor 114. The second chamber 110 has an entrance end 110a and an exit end 110b, wherein the entrance end 110a is connected to the hydrogen flow channel 106, and the exit end 110b is connected to a FC stack. The first chamber 108 contains water 116, and the second chamber 110 contains a water absorbing material 118. The water absorbing material 118 is capable of absorbing liquid and retaining its breathability.

To be humidified, the water absorbing material 118 absorbs the water 116 in the first chamber 108 so that the hydrogen gas passing through the humidification unit 104 is aquiferous. The water absorbing material 118 may be absorbent cotton. The membrane 112 is disposed between the first chamber 108 and the second chamber 110 to separate the water 116 in the first chamber 108 and the water absorbing material 118 in the second chamber 110 from each other.

The membrane destructor 114 is connected to the membrane 112. In the embodiment, the membrane destructor 114 is a heater disposed on the surface of the membrane 112, and the heater may be turned on through an external control circuit (not shown) to heat up and melt the membrane 112 so as to a hole on the membrane 112. The heater may be a resistor or an electrically heated wire.

In the embodiment, the hydrogen supply unit 102 includes a plurality of sub-units 120. Each of the sub-units 120 sequentially performs a hydrogen generation reaction under the control of the external control circuit to generate a suitable amount of hydrogen gas. For example, each sub-unit 120 includes a first reactant 122, a second reactant 124, a membrane 126, a heating element 128, and a breathable waterproof film 130, wherein the first reactant 122 and the second reactant 124 are disposed at sides of the membrane 126 and separated from each other. In the embodiment, the first reactant 122 may be solid NaBH₄, and the second reactant 124 may be water (H₂O).

The heating element 128 is disposed on the surface of the membrane 126. The heating element 128 heats up and melts the membrane 126 to form a hole on the membrane 126. Accordingly, the first reactant 122 and the second reactant 124 of the sub-unit 120 get into contact through the hole on the membrane 126 and react with each other to generate hydrogen gas. The heating element 128 may be a resistor or an electrically heated wire. In addition, the sub-units 120 may selectively include a pressure supply element 132 disposed above the second reactant 124, wherein the pressure supply element 132 pushes the second reactant 124 towards the first reactant 122 to allow the two to well react with each other.

The hydrogen flow channel 106 is connected between the hydrogen supply unit 102 and the second chamber 110 of the humidification unit 104. In an embodiment, the hydrogen flow channel 106 is connected under the sub-units 120. The hydrogen flow channel 106 has an end 106a. The end 106a of the hydrogen flow channel 106 is connected to the entrance end 110a of the second chamber 110 and then to the FC stack through the exit end 110b of the second chamber 110 so that the hydrogen gas generated by the hydrogen supply unit 102 may be supplied to the FC stack. Because the breathable waterproof film 130 is disposed between the sub-units 120 and the hydrogen flow channel 106, the hydrogen gas generated by the sub-units 120 flows into the hydrogen flow channel 106 underneath through the breathable waterproof film 130. However, because the breathable waterproof film 130 may prevent the second reactant 124 from entering the hydrogen flow channel 106, the second reactant 124 may not be leaked into the FC stack or affect the perfoimance of the FC.

Referring to FIG. 1B, when it is detected that the FC stack has insufficient electricity, the heating elements 128 of one or multiple sub-units 120 in the hydrogen supply unit 102 are controlled according to the electricity consumption of the FC stack to heat up and melt the membranes 126, so that the second reactant 124 reacts with the first reactant 122 to generate a proper amount of hydrogen gas. It should be mentioned herein that when or before the hydrogen supply unit 102 generates hydrogen gas, the membrane destructor 114 of the humidification unit 104 may heat up and melt the membrane 112 to form a hole thereon. Then, the water 116 in the first chamber 108 flows into the second chamber 110, and the water absorbing material 118 in the second chamber 110 absorbs the water 116 and turns into a water-soaked water absorbing material 118′. Namely, the hydrogen gas generated by the hydrogen supply unit 102 is collected into the hydrogen flow channel 106 through the breathable waterproof film 130 and then passes toward the second chamber 110 of the humidification unit 104 through the end 106a of the hydrogen flow channel 106. The hydrogen passing through the water-soaked water absorbing material 118′ in the second chamber 110 carries water vapour, which is then conducted to the FC stack 134 through the exit end 110b. Since the water-soaked water absorbing material 118′ is still breathable, the efficiency of conducting hydrogen to the FC stack 134 is not affected.

To be specific, in the embodiment described above, the humidification unit 104 is disposed in the fuel cartridge 100, and the humidification unit 104 has two chambers 108 and 110 that are separated from each other, wherein the chamber 108 contains water 116, and the chamber 110 contains the water absorbing material 118. To humidify the hydrogen gas, the water absorbing material 118 absorbs sufficient water to form a water-soaked region. Besides, the humidification unit 104 is placed at the end 106a of the hydrogen flow channel 106. When the sub-units 120 of the hydrogen supply unit 102 perform the hydrogen generation reaction, the generated hydrogen gas passes through aforementioned water-soaked region (the water-soaked water absorbing material 118′) so that the adequately water-soaked hydrogen gas may be directly conducted into the FC stack 134. Thereby, it is not needed to dispose any additional humidifier in the FC system to maintain the humidity of the proton exchange membrane in the FC stack 134, and accordingly the performance of the system may be maintained or even improved.

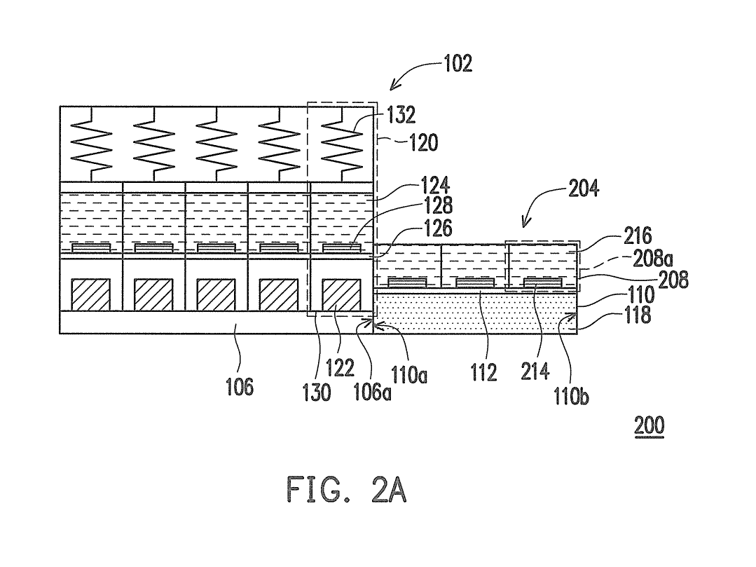

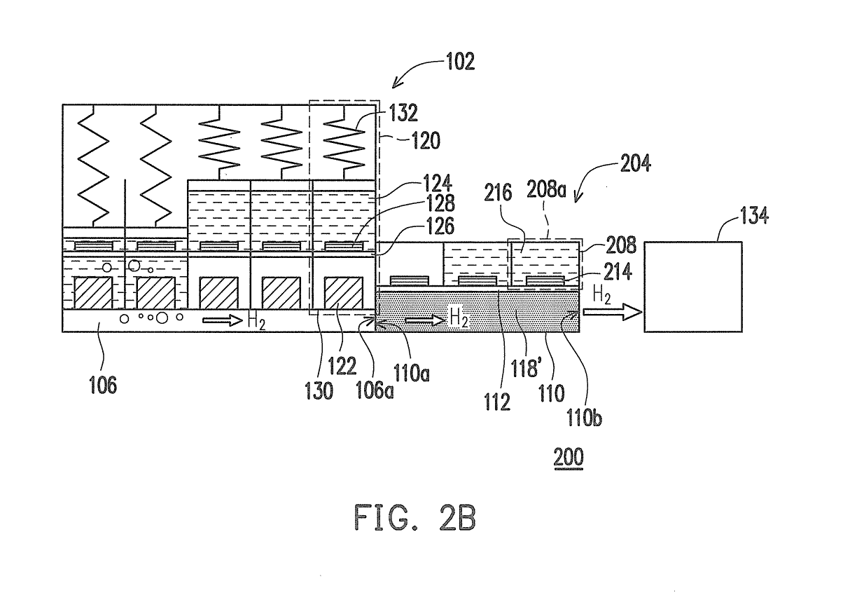

FIG. 2A and FIG. 2B are respectively a cross-sectional diagram of a fuel cartridge before and after its operation according to another embodiment of the invention. Those elements in FIG. 2A and FIG. 2B similar to those in FIG. 1A and FIG. 1B are marked with the same reference numerals and will not be described herein.

Referring to FIG. 2A, in the embodiment, the fuel cartridge 200 illustrated in FIG. 2A is composed of almost the same components as those of the fuel cartridge 100 illustrated in FIG. 1A, and the difference between the two fuel cartridges falls on the structure of the first chamber of the humidification unit. In the embodiment illustrated in FIG. 1A, the first chamber 108 is a single chamber, while in the embodiment illustrated in FIG. 2A, the first chamber 208 includes a plurality of sub-chambers 208a, wherein these separated sub-chambers 208a respectively contain water 216, and the water 216 in the sub-chambers 208a is not connected with each other. In the embodiment, a membrane destructor 214 is correspondingly disposed on the surface of the membrane 112 in each of the sub-chambers 208a.

Referring to FIG. 2B, to humidify the hydrogen gas, one or multiple membrane destructors 214 in the humidification unit 204 may heat up and melt the membrane 112 so as to form a hole thereon. Then, the water 216 in the corresponding sub-chamber 208a flows into the second chamber 110, and the water absorbing material 118 absorbs the water 216 and turns into a water-soaked water absorbing material 118′. Accordingly, the hydrogen gas generated by the hydrogen supply unit 102 is conducted to the hydrogen flow channel 106 through the breathable waterproof film 130. The hydrogen is adequately humidified after it passes through the water-soaked water absorbing material 118′ in the second chamber 110 of the humidification unit 204 through the end 106a of the hydrogen flow channel 106 therefore may be directly conducted to the FC stack 134.

It should be mentioned that in the embodiment, the first chamber 208 of the humidification unit 204 is divided into a plurality of sub-chambers 208a, such that the water absorbing material 118 may respectively absorb the water 216 in the sub-chambers 208a for multiple times, and the usage frequency of the humidification unit 204 may thus be increased. In addition, the quantity of the water 216 in each sub-chamber 208a of the humidification unit 204 flowing to the water absorbing material 118 may be controlled according to the number of hydrogen generation reactions performed by the hydrogen supply unit 102 and the quantity of hydrogen gas to be generated, so as to repeatedly form the water-soaked water absorbing material 118′ (water-soaked region). Thereby, the humidity of hydrogen gas is always maintained at an appropriate degree.

In summary, in at least one embodiment of the invention, a humidification unit is disposed in a fuel cartridge, and hydrogen gas generated by a hydrogen supply unit is conducted as a fuel gas to a FC stack via a water-soaked water absorbing material in the humidification unit. Thus, the hydrogen gas is adequately humidified by the humidification unit and may be directly conducted to the FC stack to maintain the humidity of a proton exchange membrane. Thereby, no complicated humidifier is to be disposed in the system. Moreover, the humidification unit has two chambers that are separated from each other by a membrane, wherein the two chambers respectively contain water and the water absorbing material. To humidify the hydrogen gas, a hole is formed on the membrane by a membrane destructor, and the water flows into the chamber containing the water absorbing material through the hole and is absorbed by the water absorbing material. Besides, the first chamber of the humidification unit may be divided into a plurality of sub-chambers, so that the water absorbing material may respectively absorb the water in the sub-chambers for multiple times, and the usage frequency of the humidification unit may thus be increased.

Furthermore, embodiments of the invention described above may be applied to a FC system. A hydrogen humidification function may be accomplished by disposing a humidification unit in the fuel cartridge. Thereby, the technique in the embodiments of the invention offers a simple design and it is easy to produce.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all teems are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A fuel cartridge, adapted to supply hydrogen gas to a fuel cell stack, the fuel cartridge comprising:
a hydrogen supply unit, capable of generating the hydrogen gas; and
a humidification unit, connected with the hydrogen supply unit, the humidification unit comprising:
a first chamber, containing water;
a second chamber, containing a water absorbing material;
a membrane, disposed between the first chamber and the second chamber; and
at least one membrane destructor, connected to the membrane, wherein the water in the first chamber flows into the second chamber and is absorbed by the water absorbing material when a hole is formed on the membrane by the membrane destructor.

2. The fuel cartridge according to claim 1 further comprising a hydrogen flow channel, wherein the hydrogen flow channel is connected between the hydrogen supply unit and the second chamber so that the hydrogen gas generated by the hydrogen supply unit is supplied from the hydrogen flow channel to the fuel cell stack through the water-soaked water absorbing material.

3. The fuel cartridge according to claim 1, wherein the membrane destructor comprises a heater connected to the membrane, and the heater is capable of heating up and melting the membrane to form the hole on the membrane.

4. The fuel cartridge according to claim 3, wherein the heater is a resistor or an electrically heated wire.

5. The fuel cartridge according to claim 1, wherein the first chamber comprises a plurality of sub-chambers, the sub-chambers are not connected with each other, and each of the sub-chambers has one of the membrane destructors respectively.

6. The fuel cartridge according to claim 1, wherein the hydrogen supply unit comprises a plurality of sub-units capable of sequentially generating the hydrogen gas.

7. A humidification unit, adapted to a fuel cartridge, the humidification unit comprising:
a first chamber, containing water;
a second chamber, containing a water absorbing material;
a membrane, disposed between the first chamber and the second chamber; and
at least one membrane destructor, connected to the membrane, wherein the water in the first chamber flows into the second chamber and is absorbed by the water absorbing material when a hole is formed on the membrane by the membrane destructor.

8. The humidification unit according to claim 7, wherein the membrane destructor comprises a heater connected to the membrane, and the heater is capable of heating up and melting the membrane to form the hole on the membrane.

9. The humidification unit according to claim 8, wherein the heater is a resistor or an electrically heated wire.

10. The humidification unit according to claim 7, wherein the first chamber comprises a plurality of sub-chambers, the sub-chambers are not connected with each other, and each of the sub-chambers has one of the membrane destructors respectively.
